(19) United States
(12) Patent Application Publication
(10) Pub. No.: US 2023/0214660 A1
(43) Pub. Date: Jul. 6, 2023

(54) HYBRID TRAINING METHOD FOR SELF-LEARINING ALGORITHMS

(71) Applicant: ZF Friedrichshafen AG, Friedrichshafen (DE)

(72) Inventors: Christian Riess, Wangen (DE); Fabio Da Costa Ferreira, Weingarten (DE); Daniel Wolf, Friedrichshafen (DE); Dietmar Tilch, Marktheidenfeld (DE); Tobias Ehlgen, Ravensburg (DE)

(73) Assignee: ZF Friedrichshafen AG, Friedrichshafen (DE)

(21) Appl. No.: 17/996,232

(22) PCT Filed: Mar. 16, 2021
(86) PCT No.: PCT/EP2021/056648

§ 371 Date: Oct. 14, 2022

(30) Foreign Application Priority Data
Apr. 15, 2020 (DE) 10 2020 204 715.4

(51) Int. Cl. G06N 3/0895

(52) U.S. Cl. CPC G06N 3/0895

(57) ABSTRACT

A method for training a self-learning algorithm, where the algorithm is designed, as a function of one or more physical parameters of a technical device, to predict one or more values of one or more physical parameters of the device. The algorithm undergoes a basic training using values of the physical parameters that have been obtained by simulation of at least part of the device. The algorithm then undergoes build-up training with measured values of the physical parameters.

### RELATED APPLICATIONS

This applicationclaims the benefit under 35 U.S.C. § 371 as a U.S. National Application of application no. PCT/EP2021/056648, filed on 16 Mar. 2021, which claims benefit of German Patent Application no. 10 2020 204 715.4 filed 15 Apr. 2020, the contents of which are hereby incorporated herein by reference in their entireties

### FIELD OF THE DISCLOSURE

The invention relates generally to machine learning and more particularly to a method for detecting anomalies in a technical device.

### BACKGROUND

From the prior art, approaches are known for training neuronal networks using simulation data.

### SUMMARY

The purpose of the present invention is to improve the training of self-learning algorithms. This objective is achieved by a method for detecting anomalies in a technical device. Preferred further developments and embodiments will be apparent in light of the present disclosure.

A self-learning algorithm is an algorithm which conforms to the generic term of machine learning. It is based on a model which is trained by the input of training data. The model can be a neuronal network or a statistical model. Training of a model means adaptation of the model to training data.

### DETAILED DESCRIPTION

The method according to the invention serves for the training of a self-learning algorithm. The algorithm is designed, as a function of one or more values, - one or more physical parameters of a technical device - to predict one or more values - dependent values - of one or more physical parameters of the technical device.

A physical parameter of an object of physics - in this case the device - is a quantitatively determinable property of a process or condition. A physical parameter is quantitatively determinable by virtue of the value of the parameter.

The technical device is preferably a transmission. In particular, one or more values of one or more physical parameters of a slide bearing of the transmission can be predicted.

The dependent values are predicted by computational determination. Thus, the algorithm is designed, as a function of one or more values of one or more physical parameters of the technical device, to determine one or more values of one or more physical parameters of the device by computational means. The dependence of the values is a functional dependence with the initial values as a functional parameter and the dependent values as functional values. Here, computational determination of the dependent values means the same as calculating the functional dependence.

The algorithm first undergoes a basic training. This is understood to mean training of the algorithm with values of physical parameters, which have been obtained by simulation of at least part of the device. This implies that that a simulation of at least part of the device is carried out. Preferably the simulation precedes the basic training. By the simulation, initial values and values that depend on them are determined. These serve the algorithm as training data. Preferably, values obtained exclusively by simulation are used for the basic training.

According to the invention, the basic training is followed by build-up training. Build-up training is understood to be training of the algorithm with measured values of the physical parameters. This implies that the values are measured on the device. Preferably, the build-up training is carried out exclusively with measured values. In detail, the algorithm is trained on measured initial values and the also measured values that depend on them. Preferably, the measurements are carried out before the build-up training.

Since the basic training takes place by simulation, it depends on generalizing model assumptions which compromise the accuracy of the predicted values. This defect is eliminated by the subsequent build-up training. Since the build-up training is based on measured values of the physical parameters, the self-learning algorithm is calibrated on a concrete physical instance of the device.

A database consisting of real field data is only needed for the build-up training. The training data for the basic training can be obtained by computational means in any desired quantity. Thus, the invention makes it possible to improve the precision of a self-learning algorithm without enlarging the database.

In a preferred further development, the build-up training is carried out after the basic training has been completed. This means that the basic training ends at a point in time when the build-up training begins.

The method according to the invention is preferably used as a means for the detection of anomalies in the above-mentioned technical device. In this, the initial values are determined by measurement. The dependent values are predicted by means of the algorithm. In addition, the dependent values are determined by measurement.

Anomalies can be detected by comparing the predicted dependent values with the measured dependent values. Thus, it is assumed that no anomaly exists if the predicted and measured values agree, at least to a large extent. If larger deviations are observed, this is to be attributed to an anomaly, for example to damage.

In particular, damage to slide bearings can be detected in this way. Damage to slide bearings results in a rise in temperature. Preferably therefore, the temperature of the slide bearing is measured and predicted. The measured and predicted values are compared with one another. If the values are very different, it can be assumed that the slide bearing is damaged.

1-3. (canceled)

4. A method for detecting anomalies in a technical device, the method comprising:
training of a self-learning algorithm, wherein the algorithm is configured, as a function of one or more physical parameters of a technical device, to predict one or more values of one or more physical parameters of the device, the training comprising (a) basic training using values of the physical parameters obtained by simulation of at least part of the device, and (b) build-up training using measured values of the physical parameters;
measuring one or more values of the one or more physical parameters of the device, thereby providing measured values;
predicting the one or more values of one or more physical parameters of the device as a function of the measured values by means of the algorithm, thereby providing predicted values;
measuring the predicted values, thereby providing measured predicted values; and
comparing the predicted values and the measured predicted values.

5. The method according to claim 3, wherein the build-up training is carried out after the basic training has been completed.
